(19) United States
(12) Patent Application Publication
(10) Pub. No.: US 2019/0306481 A1
(43) Pub. Date: Oct. 3, 2019

(54) DEPTH COLOR CORRECTION

(71) Applicant: Paralenz Group ApS, Copenhagen K (DK)

(72) Inventor: Thomas Peter Sønderby, Copenhagen O (DK)

(21) Appl. No.: 16/363,962

(22) Filed: Mar. 25, 2019

Related U.S. Application Data
(60) Provisional application No. 62/649,445, filed on Mar. 28, 2018.

(51) Int. Cl. H04N 9/73; H04N 1/50

(52) U.S. Cl. CPC H04N 9/73; H04N 1/506

(57) ABSTRACT

The invention relates to an underwater digital video camera for adjusting color correction settings in response to changing current depths during recording of video. The camera has a control system for adjusting color correction settings and receives current depths of the video camera from a depth gauge. The control system repeatedly adjusts color correction settings based on the received current depths during recording of video.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present disclosure relates to an underwater digital video camera, in particular such video camera applying a color correction that depends on the depth of the camera.

### BACKGROUND

It is well-known that the light absorption spectrum of water has a significant impact and underwater photography, and that the deeper the more the warm (red) colors are suppressed, resulting in images dominated by colder (green and blue) colors.

U.S. Pat. No. 7,760,994 and EP 2 550 559 B1 describe digital underwater cameras involving a depth sensor, a focus finder and a color correction scheme applied to recorded images that depends on the total water path length of the light from the recorded object. The total water path length can be either the distance from an underwater light source to the object and then to the camera, or the distance from the water surface (light source is the sun) to the object and then to the camera. It is a disadvantage that the applied correction is only suited for still image recording

### SUMMARY

It is an object of the invention to provide an underwater digital video camera that automatically adjusts a color correction setting during recording.

It is another object of the invention to provide an underwater digital video camera that automatically adjusts a color correction in response to changing depths.

In a first aspect, the invention provides an underwater digital video camera having a control system for adjusting color correction settings for correcting color in video recorded by the video camera, the control system being adapted to receive a current depth of the video camera and repeatedly adjust the color correction settings based on a received current depth of the video camera during recording of the video, i.e. without interrupting video recording. Thereby, when a first part of a video is recorded at a first depth and a second part of the video is recorded at a second, different depth, the control system will set the color correction settings differently for the first and second parts without interrupting video recording. This color correction based on current depth is referred to as depth color correction or DCC.

In a second aspect, the invention provides a method for performing color correction during recording of an underwater video with an underwater, digital video camera, the method comprising the following steps to be carried out repeatedly during recording of video: determining a current depth of the video camera; and adjusting color correction settings based on a determined current depth.

In the present description, an underwater video camera is any camera suitable for recording a video underwater, including a camera placed in an underwater housing. The color correction based on current depth is also referred to as depth color correction, or DCC. The current depth of the video camera includes any data indicative of such depth, such as pressure data or similar. Hence, when referring to “depth” in relation to data from the depth gauge or data stored or processed by the control system, any such data indicative of a depth is meant. Also, the depth of the video camera is to be understood as a depth in the immediate vicinity of the video camera, as the size of the video camera itself causes it to cover a depth range and since the depth gauge may be external to the video camera.

The gist of the invention is that DCC settings are adjusted in response to changing current depths during recording of video and not simply set one time when the recording starts. This has the advantage that when the color correction will not become insufficient or exaggerated when the depth changes substantially during video recording.

### BRIEF DESCRIPTION OF THE DRAWINGS

FIG. 1 is an illustration of the different DCC settings for different depths.

FIG. 2 is a graph illustrating the dependence on a DCC setting coefficient as a function of depth.

FIG. 3 is an illustration of a video camera in accordance with an embodiment of the invention.

FIG. 4 is a chart illustrating architecture and processes of different embodiments of the invention.

FIG. 5 is a flow chart illustrating embodiments related to triggering adjustment of the color correction settings.

### DETAILED DESCRIPTION

Color correction, also sometimes referred to as color reproduction or saturation correction, is commonly provided using a 3×3 linear space color correction matrix (CCM) acting on the RGB values (or similar in other color spaces) will be used in the following. Simpler as well as more complex (higher order, non-linear color correction methods) are described in the prior art and may also be used. The CCM is typically written as:

$$[ \begin{matrix}{R}_{DCC} \\ {G}_{DCC} \\ {B}_{DCC}\end{matrix} ] = [ \begin{matrix}{A}_{0} & {A}_{1} & {A}_{2} \\ {B}_{0} & {B}_{1} & {B}_{2} \\ {C}_{0} & {C}_{1} & {C}_{2}\end{matrix} ] \cdot [ \begin{matrix}R \\ G \\ B\end{matrix} ] ,$$

where R, G, B are the starting values, A0-2, B0-2, C0-2 the gain coefficients and RDCC, GDCC, BDCC are the depth color corrected RGB values. The CCM is the digital version of a red colored filter sometimes used before the lens in underwater photography, but more versatile since it can be used attenuate or intensify any color component. The color correction is applied to image date of each frame of the video and will typically be the same for all frames.

A color correction matrix can be used to adjust the colors of an underwater video to compensate for the wavelength dependent attenuation of water as a function of the depth. Water attenuates longer wavelength light faster than shorter wavelength. This results in videos with a strong green/blue hue or in other words a lack of red color.

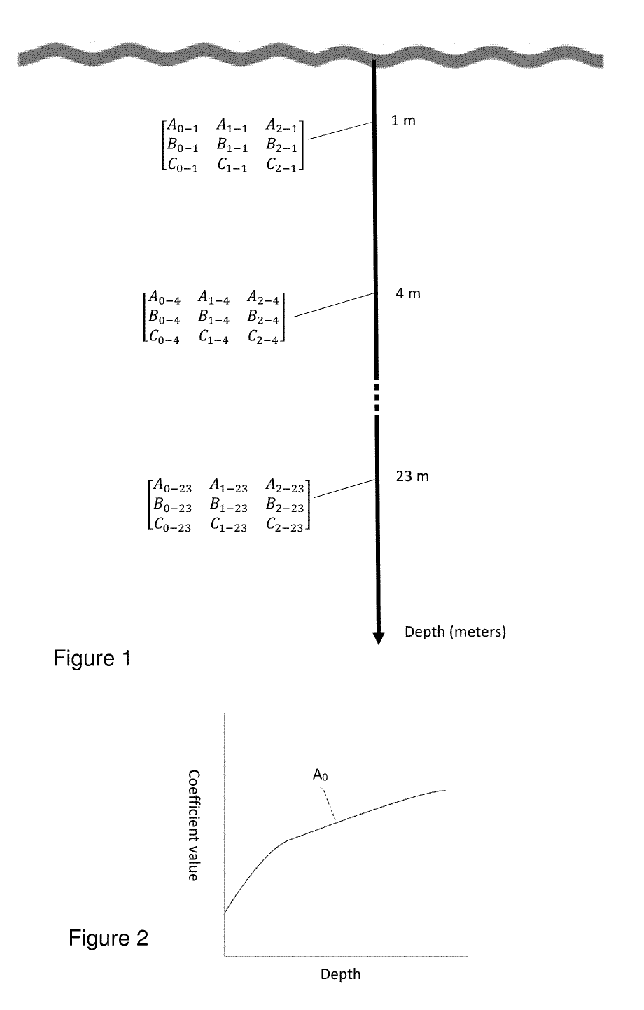

With depth color correction according to an embodiment of the invention using CCMs, the matrix coefficients will change according to the current depth of the video camera. Thus, for a certain depth, and water type there will be a corresponding CCM as shown in FIG. 1 and the color correction will be different for frames recorded at different depths. Alternatively, each of the CCM coefficients can be described as a function of depth by an equation or a curve as demonstrated for A0 in FIG. 2. A similar curve or equation will exist for each of the CCM coefficients with this method. In this embodiment, the term color correction settings refers to the CCM coefficient values currently applied by the control system, and the term color correction versus depth profile refer to a set of all coefficients for all depths.

White balance (WB) correction is a special case of color correction serving to make sure that white elements in a scene also appear white in the recorded image. The need for white balance correction is therefore determined by the color temperature of the light incident on the object as well as absorption of light between the object and the camera. In the present invention, only the effect of the color temperature of the light incident on the object as determined by the depth of the object (and the water type) will be taken into account.

White balance can also be described with a CCM:

$$[ \begin{matrix}{R}_{WB} \\ {G}_{WB} \\ {B}_{WB}\end{matrix} ] = [ \begin{matrix}{A}_{1} & 0 & 0 \\ 0 & {A}_{2} & 0 \\ 0 & 0 & {A}_{3}\end{matrix} ] \cdot [ \begin{matrix}R \\ G \\ B\end{matrix} ]$$

Often the WB gain coefficients are calculated with reference to a white point (or grey point). At a white/grey point the RGB values will optimally be equal, R=G=B. When calculating the gain coefficients A1-3, one possibility is to use the green pixel of a white or grey reference point and calculate the red and blue gain with reference to the green pixel. In this case, the WB matrix may look like this:

$$[ \begin{matrix}{R}_{WB} \\ {G}_{WB} \\ {B}_{WB}\end{matrix} ] = [ \begin{matrix}G / R & 0 & 0 \\ 0 & 1 & 0 \\ 0 & 0 & G / B\end{matrix} ] \cdot [ \begin{matrix}R \\ G \\ B\end{matrix} ]$$

In a preferred embodiment, the color correction is a white balance correction, and the color correction settings adjusted by the control system are white balance gain coefficients.

The WB gain coefficients are typically empirically determined by taking a photo (in raw format) of a white or grey reference object at different depths, perform white balance correction in post-processing and then determine the value of each gain coefficient as a function of depth. This determination of gain coefficient profiles can be used to determine color correction versus depth profiles for different underwater conditions such as the turbidity and the apparent color of the water. These different profiles can be stored in the camera and selected by the user or automatically.

Thus, in a preferred embodiment, the control system utilizes a stored color correction versus depth profile to adjust color correction settings based on the current depth, and the video camera holds multiple stored color correction versus depth profiles suitable for different underwater conditions.

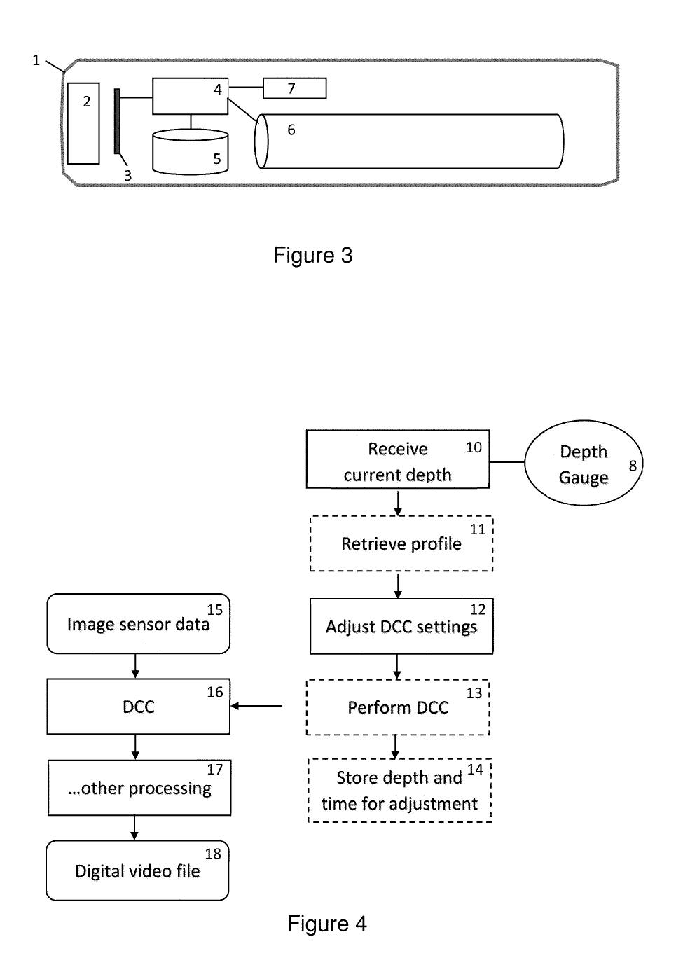

FIG. 3 illustrates a video camera 1 having imaging optics 2, a digital image sensor 3, a processor 4, memory 5, means 6 to provide a current depth of the video camera to the control system and a battery 7. The control system is provided by the processor in the form of an ASIC or software to be executed by the processor. The control system will typically be part of a larger system for operating the video camera.

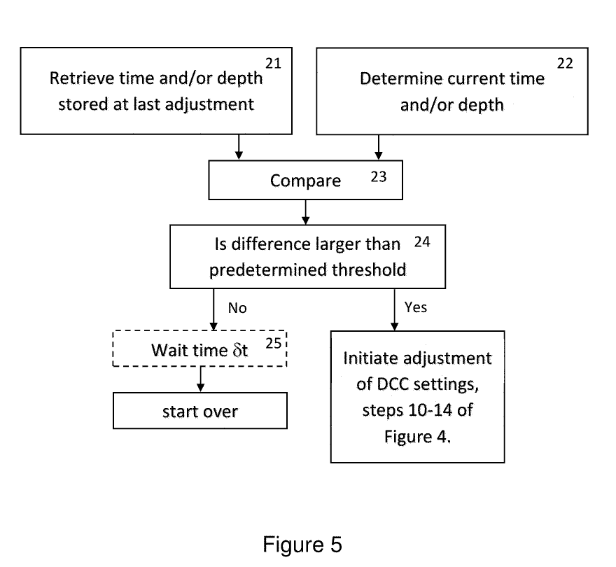

FIG. 4 is a chart illustrating the basic architecture of the software or ASIC of the control system in accordance with the aspect of a video camera or the method steps in accordance with the aspect of a method for performing color correction.

In a first embodiment, the control system receives a depth or depth-related pressure data from an electric depth gauge 8 and determines (10) a current depth of the video camera. Based on the current depth, the control system then adjusts (12) the DCC settings of the camera. In further embodiments, the control system also performs DCC (13, 16) on the recorded image sensor data (15) before the video is stored (18) in a final digital video file format. This correction on the recorded image sensor data is carried out for each frame of image sensor data, and other processing (17) such as other corrections and compression will typically also be performed before storage.

The control system may retrieve (11) a relevant color correction versus depth profile for adjusting the DCC settings.

In a further embodiment, the control system stores (14) the depth on which the most recent adjustment of the color correction settings is based and/or a time at which the most recent adjustment of the color correction settings is made. This stored data can be used in the determination of when to repeat adjustment of the DCC settings. The interval with which DCC settings are adjusted during recording is a balance between desired video quality and processing/power usage.

Adjusting DCC settings for e.g. every 2 centimeters of depth change or every 0.1 second would generally be considered as a waste of processing power and electric power without visual improvement of the video quality. Also, it would likely exceed the precision of the depth gauge. On the other hand, if the DCC settings are adjusted with too large intervals, the changes in color correction may be visible in the video as sudden changes in color.

There are, as described previously, different approaches to the repetition of DCC settings adjustment, i.e. the how the adjustment or updating of the DCC settings to be applied is triggered. These approaches use the depth and/or time data stored for the most recent adjustment of DCC settings to determine when adjustment of DCC settings are to be repeated.

In one embodiment, the control system can adjust DCC settings based on the current depth at fixed time intervals, such as at least every 0.5 second or every 1 second or every 2 seconds. Preferably, the control system repeats the adjustment of the color correction settings based on the current depth when a difference between a current time and the stored time exceeds a second predetermined threshold. This time triggered adjustment of color correction settings is advantageous since the processing and power usage is predictable and does not fluctuate.

In another embodiment, the control system adjusts DCC settings based on the current depth when the current depth has changed a predetermined amount, such as 0.1 meter, 0.5 meter, 1 meter, or 2 meters. Preferably, the control system repeats the adjustment of the color correction settings based on a current depth when a difference between a current depth and the stored depth exceeds a first predetermined threshold. This is advantageous since the DCC settings are a function of depth and thus need to be adjusted when the depth changes substantially. This changed-depth triggered adjustment of color correction settings is particularly relevant in applications where the depth changes rapidly such as in freediving. The change in depth since the last adjustment can be determined in different ways. One way may be to continuously compare the current depth from the depth gauge to the stored depth and trigger the adjustment when the difference exceeds the predetermined threshold. Another way would be to compare the current depth from the depth gauge to the stored depth at regular time intervals, St, and trigger the adjustment when the difference exceeds the predetermined threshold. Since such comparison of two depths requires very little processing power, the time interval St used may be very short, such as fractions of a second.

In yet another embodiment, the control system applies a combination of time- and changed-depth triggered adjustment of color correction settings, so that the color correction settings are adjusted upon a predetermined change in depth or time passed since the last adjustment, whichever occurs first.

FIG. 5 illustrates the different embodiments of how the adjustment of the color correction settings to be applied are triggered. In step 21, the time and/or depth stored at the last adjustment is retrieved from storage 5, and the current time and/or depth is determined in step 22. The control system compares 23 the retrieved and determined values to determine 24 whether the difference is larger than a predetermined threshold specific to the relevant data (time or depth). If the difference is not larger than the threshold, the control system may start over again immediately, or wait 25 a time interval St before starting over). If the difference is larger than the threshold, the control system initiates adjustment of the DCC settings as described in relation to steps 10-14 of FIG. 4.

The means 6 to provide a current depth of the video camera 1 to the control system may be an electric depth gauge 8 comprised by the video camera or a communication link to an external electric depth gauge 8 positioned close to the video camera and being in communication with the camera, such as via a wired or wireless communication link. Such external depth gauge would measure the depth of the depth gauge and not of the video camera and should therefore be close to the video camera, typically carried by the user of the video camera, so that it would measure the depth of the video camera+/−max. 0.5 meter. In the present description, the depth measured by such close, external depth gauge is also referred to as the depth of the video camera.

A depth gauge is most commonly a pressure sensor measuring a pressure of the water surrounding the sensor. The pressure P as a function of depth in the is given by:

P=P₀+ρg d_{G}

where P₀ is the air pressure at the upper surface of the water, ρ is the water density (1000 kg/m³), g is the acceleration due to gravity (˜9.8 m/s²) and d_{G} is the depth of the depth gauge. Preferably, the pressure sensor is calibrated to return the “gauge pressure” P_{G}=P−P₀, which is the pressure difference relative to the air pressure. The gauge pressure can be used to determine the depth of the depth gauge:

d_{G}=P_{G}/ρg.

Other types of depth gauges exist and may be used in the invention.

What is claimed is:

1. An underwater digital video camera having a control system for adjusting color correction settings for correcting color in video recorded by the video camera, the control system being configured to:
receive a current depth of the video camera;
repeatedly adjust the color correction settings based on the received current depth of the video camera during recording of the video.

2. The underwater digital video camera according to claim 1, wherein the control system is further configured to perform color correction during recording of video using one or more most recently adjusted color correction settings.

3. The underwater digital video camera according to claim 1, wherein the control system is further configured to:
store a time at which a most recent adjustment of the color correction settings is made; and
repeat the adjustment of the color correction settings based on the current depth when a difference between a current time and the stored time exceeds a second predetermined threshold.

4. The underwater digital video camera according to claim 1, wherein the control system is further configured to:
store a depth on which a most recent adjustment of the color correction settings is based; and
repeat the adjustment of the color correction settings based on a current depth when a difference between the current depth and the stored depth exceeds a first predetermined threshold.

5. A method for performing color correction during recording of an underwater video with an underwater digital video camera, the method comprising repeatedly, by a control system of the underwater digital video camera, during recording of the underwater video:
determining a current depth of the underwater digital video camera; and
adjusting color correction settings based on the determined current depth.

6. The method according to claim 5, further comprising performing color correction during recording of video using the adjusted color correction settings.

7. The method according to claim 5, further comprising storing a time at which a most recent adjustment of the color correction settings is made, wherein adjusting the color correction settings based on a determined current depth is repeated when a difference between a current time and the stored time exceeds a second predetermined threshold.

8. The method according to claim 5, further comprising storing a depth on which the most recent adjustment of the color correction settings is based, wherein adjusting the color correction settings based on a determined current depth is repeated when a difference between a current depth and the stored depth exceeds a first predetermined threshold.
